(19) United States
(12) Patent Application Publication
(10) Pub. No.: US 2011/0031328 A1
(43) Pub. Date: Feb. 10, 2011

(54) NOZZLE APPARATUS FOR DISPERSING DROPLETS OF FLOWABLE MATERIAL

(76) Inventors: Greg Rundle, Richmond (CA); Benno Bucher, Delta (CA)

Correspondence Address: CAMERON IP, SUITE 1401 - 1166 ALBERNI STREET, VANCOUVER, BC, V6E 3Z3, CA

(21) Appl. No.: 12/537,158

(22) Filed: Aug. 6, 2009

(51) Int. Cl. B05B 1/34

(52) U.S. Cl. 239/7; 239/463

(57) ABSTRACT

The present invention provides a nozzle apparatus for dispersing droplets of flowable material. The apparatus has a body with a vortex chamber, an inlet for feeding the flowable material thereto, and a passageway for supplying pressurized gas to the vortex chamber such that the flow of the pressurized gas is tangential to the flow of the flowable material. An outlet for dispersing droplets of flowable material out of the apparatus is in communication with the vortex chamber. The inlet and the outlet have cross-sectional areas which are equal to within ±15%. The passageway directs the pressurized gas to move in a vortex within the vortex chamber and envelope the flowable material. The cross-sectional area of the flowable material is thereby reduced and caused to accelerate through the outlet. Upon exiting the outlet, the flowable material spirals outwards and breaks into droplets of material thereby.

### BACKGROUND OF THE INVENTION

1. Field of the Invention

The present invention relates to a nozzle apparatus. More particularly, it relates to a nozzle apparatus for dispersing droplets of flowable material.

2. Description of the Related Art

It is known to employ pressurized gas for dispersing flowable feed where the pressurized gas is directed tangential to the feed. This is shown for example in U.S. Pat. No. 4,925,101 to Konieczynski et al. FIGS. 4 to 5 of Konieczynski illustrate an internal nozzle 38 with pressurized gas 98 passing tangentially around feed 110, in this case wax. However the device of Konieczynski employs an enlarged venturi outlet 106 to create a Venturi effect for atomization. The gas 98 constricts and thereby accelerates through passageway 102. This lowers the pressure of the gas 98. The feed 110 boils in this low pressure and a fine atomized spray emerges at the enlarged outlet 106. Atomized sprays may be undesirable because the small particles are difficult to contain. As a result, the small particles from the spray oftentimes contaminate the air surrounding, for example, the worker or the manufacturing plant generally. This may lead to health problems for workers.

For nozzle apparatuses such as that shown in Konieczynski, over time, feed 110 may also coat the surfaces around for example the outlet 106. In these cases down time for cleaning and repair of the nozzle apparatuses is eventually required. This may result in a loss of efficiency for such nozzle apparatuses, and increased parts and labour costs.

### BRIEF SUMMARY OF INVENTION

An object of the present invention is to provide an improved nozzle apparatus that overcomes the above disadvantages.

More particularly, the present invention provides a nozzle apparatus that distributes a flowable material evenly onto an irregular surface without causing atomization and with a minimum of overspray.

According to one aspect of the invention, there is provided a nozzle apparatus for dispersing droplets of flowable material. The apparatus includes a body having a vortex chamber. An inlet for feeding the flowable material therethrough extends into the body. The inlet is in communication with the vortex chamber of the body. The apparatus includes a passageway for supplying pressurized gas to the vortex chamber of the body. The passageway extends into the vortex chamber of the body such that the flow of the pressurized gas is tangential to the flow of the flowable material. The apparatus includes an outlet for dispersing droplets of flowable material out of the apparatus. The outlet extends outwards from the vortex chamber and is in communication with the vortex chamber. The inlet and the outlet have cross-sectional areas which are equal to within ±15%. The passageway directs the pressurized gas to move in a vortex within the vortex chamber and envelope the flowable material. The cross-sectional area of the flowable material is thereby reduced and caused to accelerate through the outlet. Upon exiting the outlet, the flowable material spirals outwards and breaks into droplets of material thereby.

According to another aspect of the invention, there is provided a nozzle apparatus for dispersing droplets of flowable material including a body having a hollow, frustoconical interior. The vortex chamber has an inlet end and an outlet end opposite the inlet end. The cross-sectional area of the vortex chamber narrows from the inlet end towards the outlet end. An inlet for feeding the flowable material therethrough extends into the body. The inlet is in communication with the vortex chamber of the body. The inlet is adjacent to the inlet end of the vortex chamber. The apparatus includes a passageway for supplying pressurized gas to the vortex chamber of the body. The passageway extends into the vortex chamber of the body such that the flow of the pressurized gas is tangential to the flow of the flowable material. The apparatus includes an outlet for dispersing droplets of flowable material out of the apparatus. The outlet extends outwards from the vortex chamber and is in communication with the vortex chamber. The outlet end of the vortex chamber is adjacent to the outlet. The inlet and the outlet have cross-sectional areas which are equal to within ±15%. The outlet in this example is inline and coaxial with the inlet. The passageway directs the pressurized gas to move in a vortex within the vortex chamber and envelope the flowable material. The cross-sectional area of the flowable material is thereby reduced and caused to accelerate through the outlet. Upon exiting the outlet, the flowable material spirals outwards and breaks into droplets of material thereby.

According to a further aspect of the invention, there is provided a method of dispersing droplets of flowable material from a nozzle apparatus. The nozzle apparatus has a vortex chamber, an inlet in communication with the vortex chamber, and an outlet in communication with the vortex chamber. The method includes the step of sizing the inlet and the outlet to have cross-sectional areas which are equal to within ±15%. The method includes feeding the flowable material through the inlet and into the vortex chamber. The method includes supplying a flow of pressurized gas to the vortex chamber tangential to the flow of the flowable material, the flow of pressurized gas thereby moving in a vortex within the vortex chamber and enveloping the flowable material. The cross-sectional area of the flowable material is thereby reduced and accelerated towards the outlet. Upon exiting the outlet, the flowable material spirals outwards and breaks into droplets of material thereby.

### BRIEF DESCRIPTION OF DRAWINGS

The invention will be more readily understood from the following description of preferred embodiments thereof given, by way of example only, with reference to the accompanying drawings, in which:

FIG. 1 is a front, top isometric view of a nozzle apparatus according to one embodiment of the invention;

FIG. 2 is a front, top, exploded isometric view of the nozzle apparatus of FIG. 1;

FIG. 3 is a rear, top exploded isometric view of the nozzle apparatus of FIG. 1;

FIG. 4 is a sectional view taken along section 4-4 of the nozzle apparatus of FIG. 1 with droplets of flowable material dispersing therethrough;

FIG. 5 is a front, top isometric view of a nozzle apparatus according to another embodiment of the invention;

FIG. 6 is a front, top, exploded isometric view of the nozzle apparatus of FIG. 5;

FIG. 7 is a rear, top exploded isometric view of the nozzle apparatus of FIG. 5; and

FIG. 8 is a sectional view taken along section 8-8 of the nozzle apparatus of FIG. 5 with droplets of flowable material dispersing therethrough.

### DESCRIPTION OF THE PREFERRED EMBODIMENTS

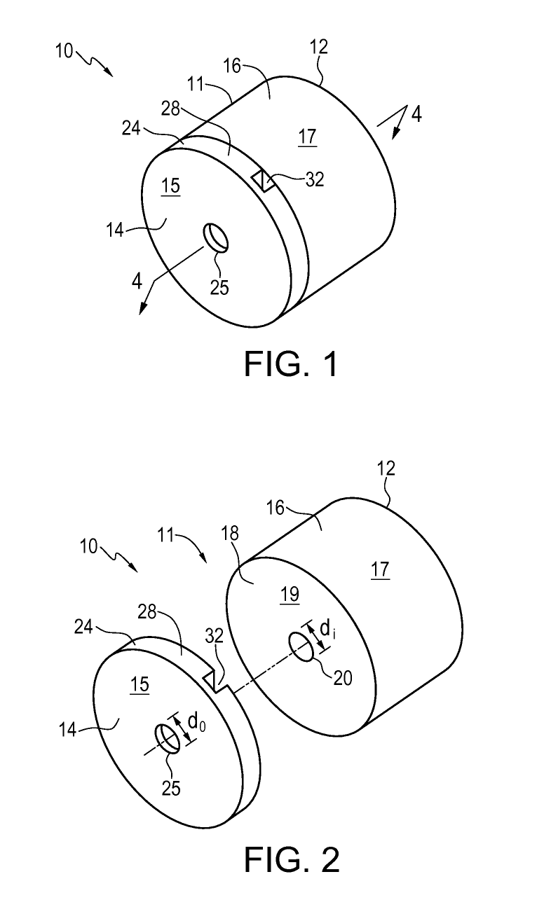

Referring to the drawings and first to FIG. 1, there is provided a nozzle apparatus 10 having a body 11. The body 11 has opposite ends 12 and 14. In this example the body 11 has a generally cylindrical shape and flat surface 15 coincides with end 14.

The body 11 in this example includes a first portion 16. The first portion 16 in this example has a cylindrical shape. Referring to FIG. 2, the first portion 16 extends from end 12 of the body 11 to an end 18 of the first portion 16. The end 18 in this example coincides with a flat surface 19 of the first portion 16. The first portion 16 has an outer, annular surface 17 which extends between end 12 of the body 11 and end 18 of the first portion 16.

An inlet 20 for feeding flowable material extends through the first portion 16 from the first end 12 through to end 18. In this example the inlet 20 is centrally disposed through the first portion 16. The inlet 20 has a diameter dᵢ. In one example dᵢ is ¼ of an inch. In another example dᵢ is 1 inch. These dimensions are only mentioned by way of example. Preferably dᵢ is within the range of 0.05 inches to 1 inches.

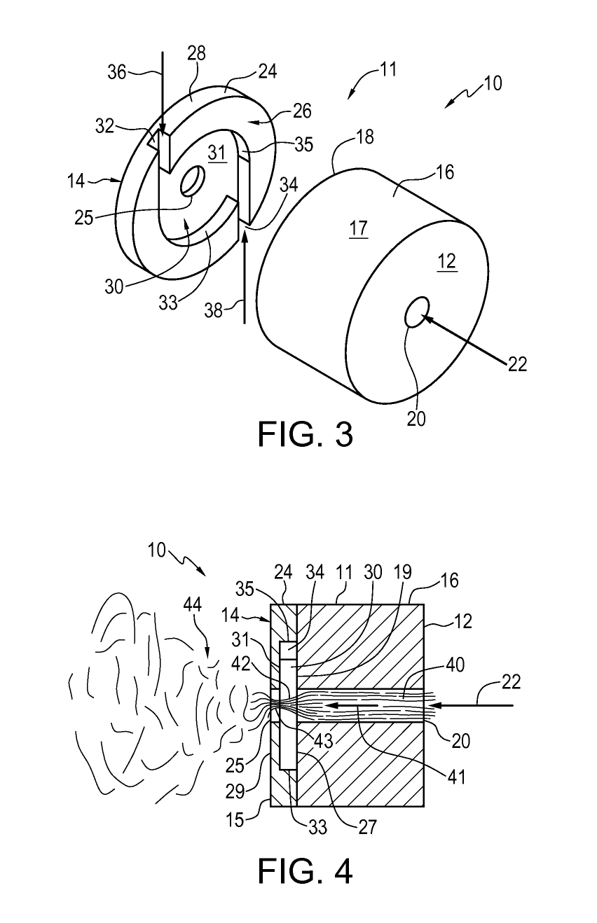

Referring both to FIGS. 2 and 3, the body 11 in this example includes a second portion 24 adjacent to the first portion 16. As shown in FIG. 3, the second portion 24 extends from end 14 of the body 11 to end 26 of the second portion 24. The second portion 24 has an outer, annular surface 28 which extends between end 14 of the body 11 and end 26 of the second portion 24.

The second portion 24 includes a vortex chamber 30. The vortex chamber 30 in this example is a recess extending from end 26 towards end 14 of the body 11. The vortex chamber 30 in this embodiment has a cylindrical shape. Referring to FIG. 4 the vortex chamber 30 has an inlet end 27 adjacent to the flat surface 19 of the first portion 16. The vortex chamber 30 also has an outlet end 29 spaced-apart from the inlet end 27. The outlet end 29 in this example coincides with a flat surface 31. Partially annular, interior surfaces 33 and 35 of the vortex chamber 30 extend between the inlet end 27 and the outlet end 29.

As best shown in FIG. 3, a first passageway 32 extends from the outer surface 28 of the second portion 24 to the vortex chamber 30. In this example there is also a second passageway 34 that extends from the outer surface 28 of the second portion 24 to the vortex chamber 30. The passageways 32 and 34 are tangential to the interior surfaces 33 and 35, respectively. In this example the first passageway 32 extends parallel to the second passageway 34.

Referring to FIGS. 2 and 3, an outlet 25 extends from end 14 of the body 11 to the vortex chamber 30. The outlet 25 has a diameter dₒ. The cross-sectional area of the outlet 25 and the cross-sectional area of the inlet 20 are equal to within ±15%. In the present preferred embodiment illustrated in FIGS. 1 to 4, the outlet 25 has the same cross-sectional area as that of the inlet 20. In this example the outlet 25 is aligned with and coaxial with the inlet 20.

In operation and referring to FIGS. 3 and 4, flowable material is feedable into inlet 20 of the first portion 16 of the body 11. The flowable material, for example a sauce or paste, is fed through the inlet 20 as shown by arrows 22 and 41 to form a product stream 40. The product stream 40 passes through the inlet 20 and into the vortex chamber 30. The product stream 40 enters the vortex chamber 30 at the same time as pressurized gas enters through the passageways 32 and 34. The passageways 32 and 34 are for supplying pressurized gas to the vortex chamber 30 of the body 11. The pressurized gas in this example is pressurized air and it is usually at low pressure. In one preferred embodiment the pressure of the air ranges from 3 to 30 PSI.

The configuration of passageways 32 and 34 causes the pressurized gas to circulate within the vortex chamber 30 tangential to the direction of the product stream 40, as is generally indicated by arrows 36 and 38 in FIG. 3. The passageways 32 and 34 direct the gas around the outside of the vortex chamber 30 adjacent to the interior surfaces 33 and 35. This causes the gas to swirl at high speed within the chamber 30. The gas forms a vortex thereby.

Because of the formation of this vortex, the gas is inhibited from mixing with the product stream. Rather, the gas envelopes the product stream 40 and twists the product stream 40 as it passes through the vortex chamber 30. The product stream 40 is caused to twist at a very high speed. In one example this may be approximately 2000 RPM.

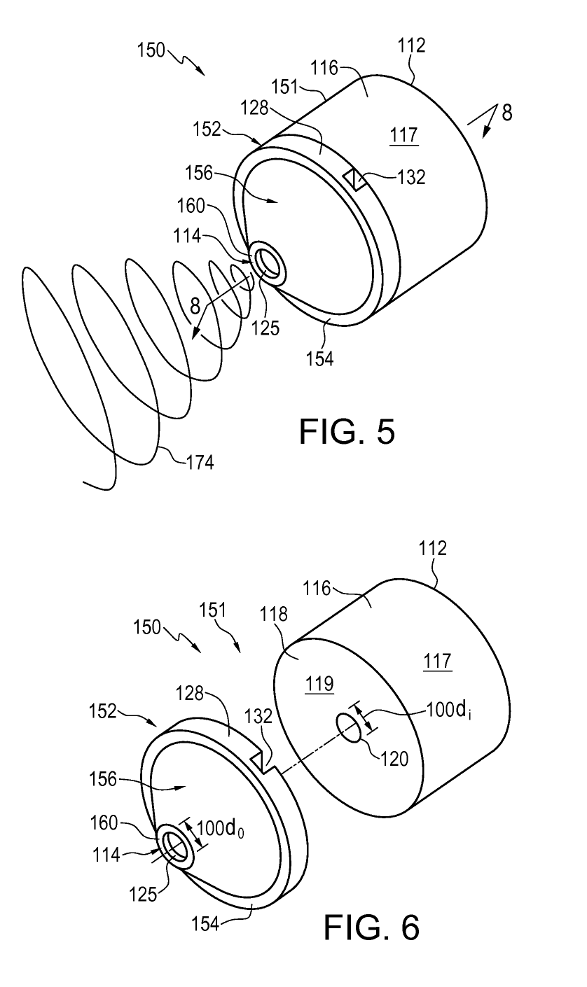

While the product stream 40 is within the vortex in the vortex chamber 30, it gets squeezed, as shown now by narrowing of the product stream 40 illustrated at 42 in FIG. 4. This is because both the gas and the product stream have to escape out of the outlet 25 which is of similar size to the inlet 20. This squeezing causes the narrowing product stream to accelerate as the gas vortex continues to twist the product stream. As this twisted stream, shown by numeral 43 in FIG. 4, exits from the outlet 25, it breaks up into separate pieces which are flung in a spiral pattern as generally shown by numeral 44. The outlet 25 is for dispersing droplets of flowable material out of the apparatus 10. Put another way, when the twisting product stream hits the atmosphere, a flinging action causes the product stream to break into droplets, which keep on traveling in a spiral fashion. The spiral pattern 44 illustrated in FIG. 4 may alternatively take a shape similar to that shown in FIG. 5 and labelled by numeral 174. Because of the spiral effect of droplets, the nozzle apparatus 10 is capable of distributing a substantial but controlled amount of flowable material in a short span of time.

The fact that the nozzle apparatus 10 avoids atomization of the flowable material is very important and advantageous, because of overspray and health reasons.

The nozzle apparatus 10 therefore may be used for applying difficult to spread food products such as tomato sauce having seeds and skins. The nozzle apparatus 10 is advantageously capable of dispersing whatever particulates fit through the inlet 20 and the outlet 25. A significant feature therefore of the present invention is its ability to handle suspended particulates such as seeds, small lumps of food or even sand. It may also for example be used for high viscosity pastes such as room temperature peanut butter or room temperature icings. Likewise, the nozzle apparatus 10 may be used for example to apply coatings for construction and machine manufacturing.

Also, because the gas envelopes the product stream, it inhibits the product stream from contacting the flat surface 31 of the vortex chamber 30, interior surfaces 33 and 35 of the vortex chamber 30, and the flat surface 19 adjacent to the vortex chamber 30. Likewise, the product stream, for example shown by numeral 43, does not contact the outlet 25. A laminar flow of rotating gas enveloping the product stream inhibits the product stream from touching the outlet 25. As a result, the product stream is inhibited from sticking to and possibly clogging the vortex chamber 30 and the outlet 25. This therefore reduces the amount of maintenance and cleaning required for the nozzle apparatus 10.

The nozzle apparatus 10 of the present invention offers further advantages over existing nozzles. All components of the apparatus 10 are stationary, in contrast to many nozzles which have moving parts. This results in an apparatus 10 that is more robust and long lasting. Because the nozzle apparatus 10 employs few parts, it is easy to take apart and clean.

A further embodiment of the present invention is shown in FIGS. 5 to 8 which are similar to FIGS. 1 to 4 and like parts have like numbers with the additional designation “1XX”. A nozzle apparatus 150 is shown having a body 151. Only the nozzle apparatus' second portion 152 has been modified in this embodiment. Only the second portion 152 therefore will be described in detail.

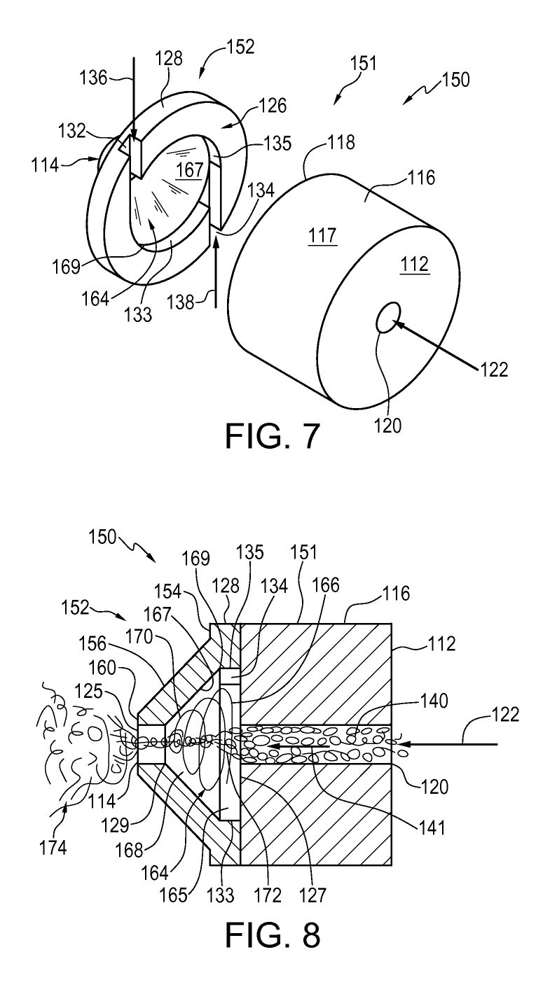

The second portion 152 is adjacent to the first portion 116. Referring to FIGS. 7 and 8, the second portion 152 extends from end 114 of the body 151 to end 126 of the second portion 152. The second portion 152 has an annular outer surface 128 which extends from end 126 of the second portion 152 to an annular shoulder 154, as shown in FIG. 5. A frustoconical outer wall 156 extends from the shoulder 154 to the end 114 of the body 151. The outer wall 156 extends radially inwards from the shoulder 154 towards outlet 125. A flat, annular surface 160 is disposed between the outer wall 156 and the outlet 125. The flat surface 160 coincides with the end 114 of the body 151. Referring to FIG. 6, the outlet 125 with its diameter 100dₒ is shown as generally the same size as the inlet 120 with its diameter 100dᵢ. However the outlet 125 may have a cross-sectional area within ±15% of that of the inlet 120. In this example the outlet 125 is coaxial with the inlet 120.

As shown in FIGS. 7 and 8, the second portion 152 includes a vortex chamber 164. The vortex chamber 164 in this embodiment is generally frustoconical in shape. The vortex chamber 164 extends from end 126 of the second portion 152 towards end 114 of the body 151.

The vortex chamber 164 has interior surfaces 133 and 135 which extend from inlet end 127 of the vortex chamber 164 to an annular shoulder 169. The vortex chamber 164 has a first zone 165 located between inlet end 127 of the vortex chamber 164, interior surfaces 133 and 135 of the vortex chamber 164, and the shoulder 169. The first zone 165 has a cylindrical shape. Passageways 132 and 134 are tangential to the interior surfaces 133 and 135, respectively, which are located in the first zone 165 of the vortex chamber 164.

A frustoconical inner wall 167 extends from the shoulder 169 to the outlet end 129 of the vortex chamber 164. The vortex chamber 164 has a second zone 168 located between the shoulder 169, the frustoconical inner wall 167, and the outlet end 129 of the vortex chamber 164. The second zone 168 of the vortex chamber 164 has a frustoconical shape.

Referring to FIGS. 7 and 8, the operation of the nozzle apparatus 150 is similar to that described for the embodiment shown in FIGS. 1 to 4. Flowable material enters inlet 120 of the first portion 116 of the nozzle apparatus 150, as generally shown by arrow 122. The flowable material forms a product stream 140 flowing in the direction indicated by arrow 141. Pressurized gas enters the second portion 152 of the nozzle apparatus 150 through passageways 132 and 134 as indicated by arrows 136 and 138. The pressurized gas enters within the first zone 165 of the vortex chamber 164. The passageways are disposed tangential and adjacent to the interior surfaces 133 and 135 and thereby cause the pressurized gas to form a vortex 166 within the vortex chamber 164. The pressurized gas envelops the product stream 140 and thereby causes it to narrow, as generally indicated by numeral 172. As the vortex of pressurized gas moves towards the outlet 125, it enters the second zone 168 of the vortex chamber 164.

As shown in FIG. 8, the cross-sectional area within the second zone 168 becomes more reduced as the pressurized gas and product stream 140 move towards the outlet 125. This causes the vortex of gas to accelerate and narrow, as generally shown by numeral 170. The accelerating vortex of gas in turn further squeezes, narrows, twists and accelerates the product stream 140 disposed therewithin. The vortex of gas continues to envelope and twist the product stream 140 throughout the vortex chamber 164 and the outlet 125. The product stream 140 is thereby inhibited from contacting any of the interior walls of the vortex chamber 164 or outlet 125. Upon reaching the outlet 125, the product stream projects outwards in the form of an outwardly dispersing spiral of droplets as generally indicated by numeral 174. The spiral of droplets 174 is also shown in FIG. 5.

It will further be understood by a person skilled in the art that many of the details provided above are by way of example only and can be varied or deleted without departing from the scope of the invention as set out in the following claims.

What is claimed:

1 A nozzle apparatus for dispersing droplets of flowable material, the apparatus comprising:
a body having a vortex chamber;
an inlet for feeding the flowable material therethrough, the inlet extending into the body and being in communication with the vortex chamber of the body;
a passageway for supplying pressurized gas to the vortex chamber of the body, the passageway extending into the vortex chamber such that the flow of the pressurized gas is tangential to the flow of the flowable material; and
an outlet for dispersing droplets of flowable material out of the apparatus, the outlet extending outwards from the vortex chamber and being in communication with the vortex chamber, the inlet and the outlet having cross-sectional areas which are equal to within ±15%,
whereby the passageway directs the pressurized gas to move in a vortex within the vortex chamber and envelope the flowable material, the cross-sectional area of the flowable material being thereby reduced and caused to accelerate through the outlet and, upon exiting the outlet, the flowable material spirals outwards and breaks into droplets of material thereby.

2. The apparatus as claimed in claim 1 wherein the inlet is coaxial with the outlet.

3. The apparatus as claimed in claim 1 wherein the vortex chamber has an inlet end and an outlet end opposite the inlet end, the outlet end of the vortex chamber being adjacent to the outlet, and the passageway being adjacent to the inlet end of the vortex chamber.

4. The apparatus as claimed in claim 1 wherein the pressurized gas is pressurized air.

5. The apparatus as claimed in claim 1, wherein the vortex chamber is frustoconical.

6. The apparatus as claimed in claim 4, wherein the vortex chamber has an inlet end and an outlet end opposite the inlet end, the outlet end of the vortex chamber being adjacent to the outlet, the cross-sectional area of the vortex chamber narrowing from the inlet end towards the outlet end, the passageway being tangential to the vortex chamber.

7. The apparatus as claimed in claim 1, wherein the vortex chamber is cylindrical, the passageway being tangential to the vortex chamber.

8. The apparatus as claimed in claim 1 wherein the cross-sectional area of the inlet is the same as that of the outlet.

9. The apparatus as claimed in claim 8 wherein the inlet and the outlet have diameters within a range of 0.05 inches to 1 inch.

10. A nozzle apparatus for dispersing droplets of flowable material, the apparatus comprising:
a body having a hollow, frustoconical interior, the vortex chamber having an inlet end and an outlet end opposite the inlet end, the cross-sectional area of the vortex chamber narrowing from the inlet end towards the outlet end;
an inlet for feeding the flowable material therethrough, the inlet extending into the body and being in communication with the vortex chamber of the body, the inlet being adjacent to the inlet end of the vortex chamber;
a passageway for supplying pressurized gas to the vortex chamber of the body, the passageway extending into the vortex chamber such that the flow of the pressurized gas is tangential to the flow of the flowable material; and
an outlet for dispersing droplets of flowable material out of the apparatus, the outlet extending outwards from the vortex chamber and being in communication with the vortex chamber, the outlet end of the vortex chamber being adjacent to the outlet, the inlet and the outlet having cross-sectional areas which are equal to within ±15%, and the outlet being coaxial with the inlet,
whereby the passageway directs the pressurized gas to move in a vortex within the vortex chamber and envelope the flowable material, the cross-sectional area of the flowable material being thereby reduced and caused to accelerate through the outlet and, upon exiting the outlet, the flowable material spirals outwards and breaks into droplets of material thereby.

11. The apparatus as claimed in claim 10 wherein the cross-sectional area of the inlet is the same as that of the outlet.

12. A method of dispersing droplets of flowable material from a nozzle apparatus having a vortex chamber, an inlet in communication with the vortex chamber, and an outlet in communication with the vortex chamber, the method comprising:
sizing the inlet and the outlet to have cross-sectional areas which are equal to within ±15%;
feeding the flowable material through the inlet and into the vortex chamber; and
supplying a flow of pressurized gas to the vortex chamber tangential to the flow of the flowable material, the flow of pressurized gas thereby moving in a vortex within the vortex chamber and enveloping the flowable material, the cross-sectional area of the flowable material being thereby reduced and accelerated towards the outlet and, upon exiting the outlet, the flowable material spiraling outwards and breaks into droplets of material thereby.

13. The method as claimed in claim 12, further including the step of: dispersing the droplets of the flowable material outwards from the outlet at between 3 to 30 PSI.

14. The method as claimed in claim 12, further including the step of: causing the flowable material to twist at 2000 RPM upon exiting the outlet.
